(19) United States
(12) Patent Application Publication
(10) Pub. No.: US 2025/0383328 A1
(43) Pub. Date: Dec. 18, 2025

(54) REACTOR DEVICES, SYSTEMS, AND METHODS FOR OPTICAL STIMULATION AND CHARACTERIZATION OF MATERIALS IN A GAS ENVIRONMENT

(71) Applicant: Battelle Energy Alliance, LLC, Idaho Falls, ID (US)

(72) Inventors: Rebecca R. Fushimi, Idaho Falls, ID (US); Jason P. Malizia, Idaho Falls, ID (US); James P. Pittman, Ammon, ID (US); John T. Gleaves, Foley, MO (US)

(21) Appl. No.: 19/242,582

(22) Filed: Jun. 18, 2025

Related U.S. Application Data
(60) Provisional application No. 63/661,288, filed on Jun. 18, 2024.

(51) Int. Cl. G01N 31/10; G01N 21/75

(52) U.S. Cl. CPC G01N 31/10; G01N 21/75; G01N 2201/08

(57) ABSTRACT

A reactor, reactor system, and methods of use thereof are disclosed. The reactor includes a reactor tube, a waveguide, and a gas manifold. The reactor tube defines a reaction chamber for receiving an active solid material. The waveguide includes an optically transmitting material and an end positioned within the reaction chamber. A permeable material restraint is positioned at an end of the reactor tube that allows for gas to pass through for measurements by a measurement device. The gas manifold adjoins an end of the reactor tube opposite the material restraint. The gas manifold is configured to accommodate the waveguide and to direct gas into the reaction chamber. The method includes utilizing the reactor and/or the reactor system to determine responses of the active solid material to a transient by detecting properties of light and/or gas, resulting from interaction of the active solid material with the transient.

### CROSS-REFERENCE TO RELATED APPLICATIONS

This application claims the benefit under 35 U.S.C. § 119(e) of U.S. Provisional Patent Application Ser. No. 63/661,288, filed Jun. 18, 2024, the disclosure of which is hereby incorporated herein in its entirety by this reference.

### STATEMENT REGARDING FEDERALLY SPONSORED RESEARCH OR DEVELOPMENT

This invention was made with government support under Contract No. DE-AC07-05-ID14517 awarded by the United States Department of Energy. The government has certain rights in the invention.

### TECHNICAL FIELD

This disclosure relates generally to systems, devices and methods for a reactor system that enables optical stimulation and characterization of solid materials in a gas environment.

### BACKGROUND

Nearly 90% of chemical manufacturing relies on the use of a heterogeneous catalyst. These materials are vitally important as the starting point of the vast majority of consumer goods that support our modern society. A heterogeneous catalyst is typically a mixed metal oxide or supported metal that accelerates a desired set of chemical reactions without being consumed in the process. As such, these materials can minimize the energy intensity and environmental impact of chemical manufacturing processes. Heterogeneous catalysts are complex, multicomponent materials and only a small fraction of the external surface is actually involved in the desired chemical transformation. Understanding the so-called ‘structure-activity’ relationship is of critical importance for catalyst development companies and chemical manufacturers. At the same time, understanding the ‘structure-activity’ relationship is a vibrant, active, and well-funded area of academic research. Heterogeneous processes used in chemical manufacturing today are primarily thermocatalytic and driven by fossil fuels. There is a growing interest in the development of heterogeneous photocatalytic processes where electrical energy can be used to drive chemical reactions.

### BRIEF SUMMARY

In various embodiments, the disclosure provides a reactor. The reactor includes a reactor tube, a waveguide, a gas manifold, and a material restraint. The reactor tube defines a reaction chamber for receiving an active solid material and an inert solid material. The reactor tube includes a first end and a second end. The waveguide includes a communication end positioned outside of the reaction chamber beyond the first end and a reactor end positioned within the reaction chamber defining a reaction zone within the reaction chamber. The waveguide includes an optically transmitting material configured to illuminate or stimulate the active solid material positioned within the reaction zone. The gas manifold adjoining the first end of the reactor tube, the gas manifold configured to direct gas into the reaction chamber. The permeable material restraint positioned at the second end of the reactor tube. The permeable material restraint including a porous solid material configured to hold the inert solid material and the active solid material within the reaction chamber while allowing gas species to pass through for measurements to be performed by a measurement device.

In various embodiments, the disclosure provides a reactor system. The reactor system includes optics, a light measurement device configured to receive light from the optics, a gas measurement device, and a reactor positioned between the optics and the gas measurement device. The reactor includes a reactor tube, a waveguide, a gas manifold, and a permeable material restraint. The reactor tube defining a reaction chamber for receiving the active solid material and an inert solid material. The waveguide includes a communication end and a reactor end. The communication end positioned outside of the reaction chamber beyond the top of the reactor tube and positioned to send or receive light from the optics. The reactor end positioned within the reaction chamber, the waveguide including an optically transmitting material configured to disperse the light received or collected from the optics that allows detection of at least one type of properties from interaction of an active solid material with a at least one stimuli chosen from among gas and light. The gas manifold adjoins a top of the reactor tube. The gas manifold configured to accommodate the waveguide and feed the gas into the reaction chamber. The permeable material restraint positioned at a bottom of the reactor tube adjacent to the gas measurement device. The permeable material restraint configured to hold the inert solid material and the active solid material within the reaction chamber while allowing gas to pass through for the gas measurement device to detect the at least one type of gas properties.

In various embodiments, the disclosure provides a method. The method includes feeding at least one transient chosen from among a gas transient and a light transient into a reaction chamber of a reactor via a gas manifold adjoining a first end of a reactor tube of the reactor. The reactor may be any embodiment of the reactor disclosed herein. The method also includes determining responses of the active solid material to the at least one transient by detecting at least one type of properties, chosen from among properties of light and properties of gas, resulting from interaction of the active solid material with the at least one transient.

### BRIEF DESCRIPTION OF THE DRAWINGS

For a detailed understanding of the disclosure, reference should be made to the following detailed description, taken in conjunction with the accompanying drawings, in which like elements have generally been designated with like numerals, and wherein:

FIG. 1 is a schematic illustration of a reactor system in accordance with embodiments of the disclosure;

FIG. 2 is a schematic illustration of a reactor system in accordance with embodiments of the disclosure;

FIG. 3 is a cross-sectional view of a reactor of a reactor system in accordance with embodiments of the disclosure;

FIG. 4 is a flowchart of a method for analyzing an active solid material and/or gas transient stimulation;

FIGS. 5A-5C are graphs illustrating a comparison of test results between embodiments of the reactor of the disclosure and a commercial reactor;

FIG. 6 is a graph illustrating UV-VIS diffuse reflectance spectra of a chromia catalyst heated in air taken at different temperatures; and

FIGS. 7A-11 are graphs illustrating test results of embodiments of the reactor of the disclosure.

### DETAILED DESCRIPTION

A reactor for conducting temporal analysis of products (TAP) methodology and transient experiments while incorporating spectroscopic measurements, such as time resolved transient spectroscopic measurement, of a solid material in a gaseous environment is disclosed. The reactor may be configured to use the TAP methodology, and gas phase detection with well-defined separation of transport and kinetics together with time-resolved spectral changes of the solid material at a millisecond time scale. The reactor may be configured to monitor a single spectroscopic feature without scanning to achieve time-dependent monitoring on the millisecond time scale.

As will be described in detail below, the reactor may include a reactor tube defining a reaction chamber configured to receive a transient gas from an adjoining gas manifold, a waveguide configured to direct light onto an active solid material positioned within the reaction chamber, and a permeable material support at an axial end of the reactor tube (opposite the gas manifold) configured to hold the active solid material and an inert solid material within the reaction chamber and to act as a window that allows gas species to pass through for measurements to be performed. The reactor may also include a heating element radially surrounding a reaction zone of the reaction chamber where the active solid material is situated around an end of the waveguide.

In the following detailed description, reference is made to the accompanying drawings which form a part hereof, and in which are illustrated specific embodiments of the disclosure. These embodiments are described in sufficient detail to enable those of ordinary skill in the art to practice the disclosure. It should be understood, however, that the detailed description, while indicating examples of embodiments of the disclosure, are given by way of illustration only and not by way of limitation. Accordingly, various substitutions, modifications, additions rearrangements, or combinations thereof are within the scope of this disclosure.

In accordance with common practice, the various features illustrated in the drawings may not be drawn to scale. The illustrations presented herein are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Additionally, various aspects or features will be presented in terms of systems or devices that may include a number of devices, components, modules, and the like. It is to be understood and appreciated that the various systems and/or devices may include additional devices, components, modules, etc., and/or may not include all of the devices, components, modules etc., discussed in connection with the figures. Furthermore, all or a portion of any embodiment disclosed herein may be utilized with all or a portion of any other embodiment, unless stated otherwise. Accordingly, the disclosure is not limited to relative sizes or intervals illustrated in any one or more of the accompanying drawings.

In addition, it is noted that the embodiments may be described in terms of a process that is depicted as method acts, a flowchart, a flow diagram, a schematic diagram, a block diagram, a function, a procedure, a subroutine, a subprogram, and the like. Although the process may describe operational acts in a particular sequence, it is to be understood that some or all of such steps may be performed in a different sequence. In certain circumstances, the steps are performed concurrently with other acts.

The terms used in describing the various embodiments of the disclosure are for the purpose of describing particular embodiments and are not intended to limit the disclosure. As used herein, the singular forms are intended to include the plural forms as well, unless the context clearly indicates otherwise. All of the terms used herein, including technical or scientific terms have the same meanings as those generally understood by one of ordinary skill in the art unless they are defined otherwise. Terms defined in this disclosure should not be interpreted as excluding the embodiments of the disclosure. Additional term usage is described below to assist the reader in understanding the disclosure.

The terms “have,” “may have,” “include,” and “may include” as used herein indicate the presence of corresponding features (for example, elements such as numerical values, functions, operations, or parts), and do not preclude the presence of additional features.

The word “exemplary” is used herein to mean “serving as an example or illustration.” Any aspect or design described herein as “exemplary” is not necessarily to be construed as preferred or advantageous over other aspects or designs.

The terms “A or B,” “at least one of A and B,” “one or more of A and B,” or “A and/or B” as used herein include all possible combinations of items enumerated with them. For example, use of these terms, with A and B representing different items, means: (1) including at least one A; (2) including at least one B; or (3) including both at least one A and at least one B. In addition, the articles “a” and “an” as used herein should generally be construed to mean “one or more” unless specified otherwise or clear from the context to be directed to a singular form.

Terms such as “first,” “second,” and so forth are used herein to distinguish one component from another without limiting the components and do not necessarily reflect importance, quantity, or an order of use. Furthermore, a reference to first and second elements does not mean that only two elements may be employed there or that the first element must precede the second element in some manner. Also, unless stated otherwise a set of elements may comprise one or more elements.

The expression “configured to” as used herein may be used interchangeably with “suitable for,” “having the capacity to,” “designed to,” “adapted to,” “made to,” or “capable of” according to a context. The term “configured” does not necessarily mean “specifically designed to” in a hardware level. Instead, the expression “apparatus configured to . . . ” may mean that the apparatus is “capable of . . . ” along with other devices or parts in a certain context.

The term “majority” in reference to a given parameter, property, or condition means and includes to a degree that one of ordinary skill in the art would understand that the given parameter, property, or condition is met with a degree of variance, such as within acceptable tolerances. By way of example, the parameter, property, or condition shall be at least greater than 50%, such as greater than about 51%, or from about 51% to about 60%, or from about 61% to about 70%, or from about 71% to about 80%, or from about 81% to about 90%.

As used herein, the term “substantially” in reference to a given parameter, property, or condition means and includes to a degree that one of ordinary skill in the art would understand that the given parameter, property, or condition is met with a degree of variance, such as within acceptable tolerances. By way of example, depending on the particular parameter, property, or condition that is substantially met, the parameter, property, or condition may be at least 90.0 percent met, at least 95.0 percent met, at least 99.0 percent met, at least 99.9 percent met, or even 100.0 percent met.

As used herein, “about” or “approximately” in reference to a numerical value for a particular parameter is inclusive of the numerical value and a degree of variance from the numerical value that one of ordinary skill in the art would understand is within acceptable tolerances for the particular parameter. For example, “about” or “approximately” in reference to a numerical value may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

As used herein, the singular forms following “a,” “an,” and “the” are intended to include the plural forms as well, unless the context clearly indicates otherwise.

As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded.

As used herein, any relational term, such as “top,” “bottom,” “upper,” “lower,” “above,” “beneath,” “side,” “upward,” “downward,” etc., is used for clarity and convenience in understanding the disclosure and accompanying drawings, and does not connote or depend on any specific preference or order, except where the context clearly indicates otherwise. For example, these terms may refer to an orientation of elements of any system when utilized in a conventional manner. Furthermore, these terms may refer to an orientation of elements of any system as illustrated in the drawings.

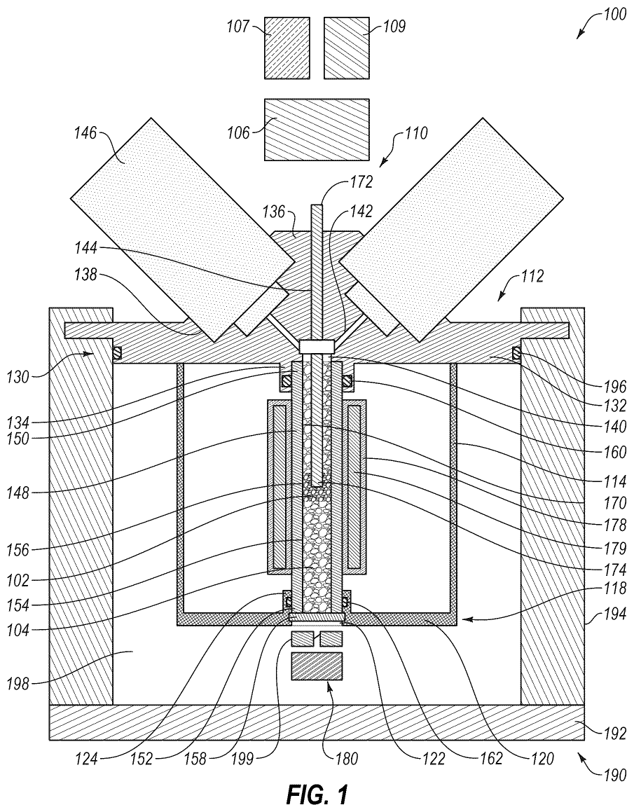

FIG. 1 is a schematic illustration of a reactor system 100 in accordance with embodiments of the disclosure. The reactor system 100 includes a reactor 110, optics 106, an optics stimulation device 107, measurement devices (e.g., an optical measurement device 109 and a gas measurement device 180), and a mounting system 190. In various embodiments, the reactor 110 is configured to perform temporal analysis of products (TAP) methodology and transient experiments while incorporating spectroscopic measurement, such as time resolved transient spectroscopic measurement of a solid material. In various embodiments, the reactor 110 includes a spectrokinetic reactor (i.e., a specialized system used to study chemical reactions by combining spectroscopy and kinetics).

In various embodiments, the reactor 110 includes a reactor tube 148, a waveguide 170, a material restraint 158, a gas manifold 136, a heater 178, and a housing 112. The reactor tube 148 includes a reaction chamber 154 formed therein extending from a first end 150 to a second end 152 of the reactor tube 148. The reaction chamber 154 is configured to receive active solid material 102 and inert solid material 104 therein, with the active solid material 102 positioned between zones of the inert sold material 104. The active solid material 102 may include, without limitation, a catalyst (e.g., a thermocatalyst), a sorbent, an electrode, a membrane, a coating, or other similar objects. The catalyst may include, without limitation, a metal, a metal oxide, a mixture of metals and metal oxides, nanoparticles, an insulator, or a semiconductor. The inert solid material 104 may include, without limitation, quartz (e.g., 250-300 μm acid washed and calcined quartz, without limitation), silicon carbide, silica, or boron nitride. The reactor tube 148 may include a hollow cylinder shape (e.g., a right circular hollow cylinder, without limitation) that defines the reaction chamber 154 within an annular wall of the hollow cylinder. The reactor tube 148 may be formed of an inert material (e.g., quartz, ceramic, steel, a high temperature plastic, such as Vespel, Inconel, Hastelloy, stainless steel, or silicon carbide, without limitation).

The waveguide 170 is configured to direct light between the optics 106 and a reaction zone 156 (e.g., spans a gap between the middle of the reactor 110 and atmosphere/optics 106 to direct light from the optics 106 to the reaction zone 156 and from the reaction zone 156 to the optics 106, without limitation) to illuminate or collect light from the active solid material 102. The waveguide 170 includes a communication end 172 and a reactor end 174. The communication end 172 is configured to receive light from optics 106 and transmit light to the optics 106. The reactor end 174 is configured to disperse the light received from the optics 106 and to collect light from the active solid material 102. The reactor end 174 is positioned within the reactor tube 148. The communication end 172 extends beyond/above the first end 150 of the reactor tube 148 and may be positioned outside of other components of the reactor 110 (e.g., gas manifold 136, without limitation). In various embodiments, the waveguide 170 includes a rod with a cylindrical shape (e.g., a solid cylinder or a hollow cylinder, such as a right circular cylinder, without limitation) that is configured as a high aspect ratio axial optical probe or image conduit. The waveguide 170 may be substantially axially aligned with the reactor tube 148 and may extend axially (in a same axial direction as the reactor tube 148) from the reactor end 174 within the reaction chamber 154, beyond the first end 150 of the reactor tube 148, to the communication end 172 with the communication end 172 positioned below the optics 106 for receiving light therefrom.

The waveguide 170 includes an optically transmitting material (e.g., sapphire, quartz, calcium fluoride, or fiber optic, without limitation).

In various embodiments, a volume of the reaction chamber 154 surrounding the reactor end 174 of the waveguide 170 within the reactor tube 148 defines the reaction zone 156 in which the active solid material 102 is positioned for analysis. The reaction zone 156 may be defined by a location of the reactor end 174 within the reactor tube 148 (e.g., a volume that extends from predetermined distances from above and below the reactor end 174 and that includes the reactor end 174, without limitation) and/or demarcations on the reactor tube 148 positioned above and below a vertical position of the reactor end 174 of the waveguide 170. The reaction zone 156 may include a thin layer of the active solid material 102 (e.g., about 1 mm in height, without limitation) within the reaction chamber 154. A remainder of the reaction chamber 154 (outside of the reaction zone 156) receives the inert solid material 104, which may be positioned above and below the active solid material 102 to hold the active solid material (102) in place within the reaction zone 156 while analysis is performed. The active solid material 102 surrounded by the inert solid material 104 within the reaction chamber 154 may define a reactor bed of material (e.g., about 1 mm in height of active solid material 102 held between two zones of the inert solid material 104 within the reaction chamber 154, without limitation). The waveguide 170 may be utilized to photonically stimulate the active solid material 102.

The permeable material restraint 158 is positioned at or adjacent to the second end 152 of the reactor tube 148, distal to the communication end 172 of the waveguide 170. The permeable material restraint 158 includes a permeable solid that is configured to hold the inert solid material 104 and the active solid material 102 in place within the reaction chamber 154 while defining an axial window that permits gas to pass through for measurements to be performed by the gas measurement device 180. In various embodiments, the permeable solid is chosen from among a perforated screen and frit, without limitation. The permeable material restraint 158 may define an exit of the reactor 110 and may be positioned directly above the gas measurement device 180 (e.g., adjacent to and substantially aligned relative to an axis of the reactor 110/reactor tube 148/waveguide 170, such as about 1 millimeter above the gas measurement device 180, without limitation). With the material restraint 158 positioned at a bottom of the reaction chamber 154, measurements may be taken by the gas measurement device 180 while light is directed into the reaction chamber 154 by the waveguide 170 from above the reaction chamber 154 and undesirable inhomogeneous radial cooling of the active solid material 102 may be avoided by positioning the reactor end 174 at a location axial to the reaction zone 156.

The gas manifold 136 is configured to direct gas injection into the reaction chamber 154. The gas manifold 136 may include a transient gas feed. The gas manifold 136 may include: one or more manifold inlets 138 formed therein and configured to receive one or more valves 146 (e.g., a pulse valve and/or a switching valve, without limitation) configured to receive gas from a gas source and enable at least one of a transient kinetic measurement and the precise dosing of gas for incremental material titration; and gas feed lines 142 formed therein and configured to fluidly connect the one or more manifold inlets 138 to a manifold outlet 140. The manifold outlet 140 adjoins the reaction chamber 154 and may be configured with zero or substantially zero dead volume between the gas manifold 136 and the reactor bed of material including the active solid material 102 and the inert solid material 104. With the manifold outlet 140 arranged with a zero or substantially zero dead volume, dead volume does not have to be taken into account in the data analysis, which reduces uncertainty to experiments conducted using the reactor 110. The gas may include a reactant, inert, or mixture thereof. The gas may include nitrogen, oxygen, hydrogen, carbon dioxide, carbon monoxide, ammonia, a hydrocarbon (e.g., methane, ethane, ethylene, propane, propylene, or a combination thereof), argon, helium, and vapors of liquids including water, an alcohol (e.g., methanol, ethanol, or a combination thereof), or a long chain hydrocarbon (e.g., pentane, octane, or a combination thereof), and mixtures thereof, without limitation.

The gas manifold 136 may include a waveguide bore 144 formed therein. The waveguide 170 may extend through the waveguide bore 144 with the communication end 172 extending beyond the gas manifold 136 in a position to receive light from the optics 106. The waveguide 170 and gas manifold 136 may be arranged with an interference fit and/or sealing to accommodate reactor pressures (e.g., pressures ranging from sub-ambient to about 35 psig or pressures of about 1×10⁻⁸ to about 1×10³ torr, without limitation).

The gas manifold 136 may be configured to enable delivery of a mixed (e.g., well-mixed) gas phase to the reaction zone 156. In various embodiments, the reactor 110 may be a low-pressure reactor and the gas manifold 136 is configured to provide low pulse intensity into the reaction chamber 154.

The heater 178 includes a heating element 179 (e.g., an RF induction coil, or a resistive heating wire, without limitation). The heater 178 and the heating element 179 may be positioned radially outward from the reaction chamber 154 and around the reactor tube 148. The heater 178 and the heating element 179 may axially overlap at least the reaction zone 156 (e.g., ends of the heating element 179 extend above and below the reaction zone 156 in the axial direction, without limitation). The heater 178 may include the heating element 179 cast in a low emissivity ceramic. In various embodiments, the heating element 179 is configured to heat the reactor 110 (e.g., the reaction zone 156 and/or the reaction chamber 154, without limitation), such as from about 25° C. to about 1200° C., from about 25° C. to about 850° C., or up to a temperature less than about 650° C. With the material restraint 158 positioned at a bottom of the reaction chamber 154, the heater 178 may be positioned radially outward and adjacent to the reaction zone 156 to maintain a desired temperature of the reaction zone 156 and may prevent inhomogeneous radial thermal gradients from developing within the reaction zone 156.

In various embodiments, the reactor 110 also includes a housing 112 configured to receive the reactor tube 148 therein. In various embodiments, the housing 112 includes a housing base 118, a housing wall 114, and a cap 130 defining a housing chamber 128. The housing base 118 may include a base portion 120 defining a bottom of the housing 112. The housing base 118 includes a lower receiving portion 124 configured to receive the second end 152 of the reactor tube 148. The lower receiving portion 124 may include an annular shape extending from the base portion 120 (e.g., upwards, towards the cap 130/towards the first end 150 of the reactor tube 148). The lower receiving portion 124 may be configured to receive a lower seal 162. The lower seal 162 may be configured to accommodate the reactor pressures (e.g., pressures ranging from sub-ambient to about 35 psig or pressures of about 10⁻⁸ to about 10³ torr, without limitation).

The housing 112 includes a base opening 122 formed in the housing base 118 (e.g., the base portion 120) aligned with the second end 152 of the reactor tube 148. The base opening 122 may include a cylindrical shape and may substantially axially align with the reactor tube 148. In various embodiments, the material restraint 158 is received within the housing base 118 at the base opening 122.

The housing wall 114 extends from the housing base 118. The housing wall 114 may include a hollow cylinder shape (e.g., a right circular hollow cylinder, without limitation) that defines the housing chamber 128 therein. The housing wall 114 may be unitarily formed with the housing base 118, permanently joined to the housing base 118, or joined to the housing base 118 in a sealed manner. In various embodiments, the cap 130 includes a cap body 132 and an upper receiving portion 134. The cap body 132 is configured to removably attach to the housing wall 114 to define the housing chamber 128 with the housing wall 114 and the housing base 118. The upper receiving portion 134 is configured to receive the first end 150 of the reactor tube 148. The upper receiving portion 134 may include an annular shape extending from the cap body 132 (e.g., downwards, towards the housing base 118/towards the second end 152 of the reactor tube 148). The upper receiving portion 134 may be configured to receive an upper seal 160. The upper seal 160 may be configured to accommodate the reactor pressures (e.g., pressures ranging from sub-ambient to about 35 psig or pressures of about 10⁻⁸ to about 10³ torr, without limitation). In various embodiments, the cap 130 includes the gas manifold 136 integrated therein. In various embodiments, the gas manifold 136 couples directly to the reactor tube 148.

The optics 106 are configured to direct light at the communication end 172 of the waveguide 170 and collect light transmitted from the communication end 172 of the waveguide 170. In various embodiments, the optics 106 include optical elements (e.g., one or more of a beam splitter, a notch filter, or a monochromator, without limitation) configured to collect scattered light for spectroscopic analysis. The optics 106 may be configured to collect light, without limitation, from the ultraviolet (e.g., 120 nm-400 nm), visible (e.g., 400 nm-700 nm), and infrared (e.g., 700 nm-10,000 nm) regions of the electromagnetic spectrum.

The optics stimulation device 107 (e.g., laser, ultraviolet lamp, without limitation) is configured to generate light that is transmitted by the optics 106 to the communication end 172 of the waveguide 170. The optics stimulation device 107 may be positioned adjacent to the optics 106 (e.g., above the optics 106, without limitation).

The measurement devices include an optical measurement device 109 and a gas measurement device 180. The measurement devices are configured to detect at least one type of property chosen from among properties of light (e.g., absorption, emission, and/or scattering of light, without limitation) via the optical measurement device 109 and properties of gas (e.g., concentrations and/or chemical speciation, without limitation) via the gas measurement device 180 that result from interaction of an active solid material with a gas or with light. The measurement devices may be configured to detect change in spectroscopic features and/or kinetic features of an active solid material in response to gas phase transient (i.e., short-lived chemical species or reaction intermediates that exist in the gas phase during a reaction), a light transient, and/or material composition.

The optical measurement device 109 is positioned adjacent to the optics 106 and is configured to receive light from the optics 106 directed thereto from the communication end 172 of the waveguide 170. The optical measurement device 109 may include one or more spectrometers (e.g., a Raman spectrometer, an IR spectrometer, or a UV-VIS spectrometer, without limitation).

The gas measurement device 180 is positioned immediately adjacent to the permeable material restraint 158 (e.g., directly below the reaction chamber 154, such as about 1 millimeter below the permeable material restraint 158, without limitation). The gas measurement device 180 may include one or more spectrometers (e.g., a mass spectrometer, without limitation).

In various embodiments, the optical measurement device 109 and the gas measurement device 180 are configured to detect on a same time scale (e.g., a substantially similar amount of time). The optical measurement device 109 and the gas measurement device 180 may be configured to perform transient kinetic measurements to collect pulse titration data and isothermal measurement.

In various embodiments, the reactor system 100 is configured for the analysis of a chemically active solid material to understand the kinetic response of photonic or gas transient stimulation, such as to conduct precise kinetic characterization and titration where the time resolved (millisecond scale) spectral response of the solid phase and the spectral response of the gas phase can be directly compared. For example, light may be used to measure properties of the catalyst (e.g., redox state, structure, phase, without limitation) or properties of gas adsorbed to the catalyst surface (e.g., structure), or light may be used to drive a chemical reaction, which are kinetically characterized from the gas phase response.

In various embodiments, the reactor system 100 is configured to enable well-defined separation of the gas transport and kinetic time-dependent responses, to detect the temporal change of a singular spectral feature of interest, and to enable characterization of the kinetic response of active solid material 102 to both photonic and gas phase transients. In various embodiments, the reactor system 100 is configured to operate in the millisecond time scale and is configured to capture the kinetic rate constants that are typical to the reaction network for the adsorption, catalytic reactions, and desorption in the temperature range of their normal operational use. Accordingly, the reactor system 100 may accommodate transient experiments and provide fast detection methods to capture the spectral response on the time scale of typical reaction kinetics, which conventional systems are unable to perform. If, for example, the active solid material 102 is a catalyst, the reactor system 100 may be used to monitor the surface of the catalyst in addition to other components (e.g., reactants) of the reaction system. The millisecond time resolution of the reactor system 100 enables photocatalytic processes to be monitored.

In various embodiments, the reactor system 100 is configured to decouple the gas transport time-dependent response from the gas transformation rate, gas concentration, and surface concentration (or surface state) time-dependent responses. The waveguide 170 extending axially relative to the reactor tube 148 enables TAP style experiments without impacting the gas transport or radial thermal gradients.

In various embodiments, the mounting system 190 includes a mount base 192 configured to support the measurement device 180 and a mount walls 194. The mount walls 194 may be configured to hold and position the reactor 110 above the measurement device 180 with the reaction chamber 154 aligned (e.g., substantially axially aligned) over the gas measurement device 180. The mount walls 194 may receive the cap 130 and support the reactor 110 via the cap 130. In various embodiments, the mount walls 194 include a hollow cylinder shape and are configured to define a vacuum chamber 198 with the base 192 and the cap 130 of the housing 112. One of the cap 130 and the reactor support 194 may be configured to receive a support seal 196 configured to ensure sealing between the cap 130 and the reactor support 194.

In various embodiments, the reactor system 100 includes a moveable reactor seal 199 (e.g., a slide valve, without limitation). The moveable reactor seal 199 is configured to seal the vacuum chamber 198 below the second end 152 of the reactor tube 148 at the reactor coupling flange 191, which enables the reaction chamber 154 to be sealed and separated from the vacuum chamber 198. By sealing the reaction chamber 154 from the vacuum chamber 198, experiments with higher pressures may be conducted in the reactor 110. In various embodiments, the moveable reactor seal 199 includes an adjustable leak that can permit some or none of the reactor gas phase into the vacuum chamber 198. The moveable reactor seal 199 may also be moved out of the way such that the exit of the reaction chamber 154 is directly open to the gas measurement device 180.

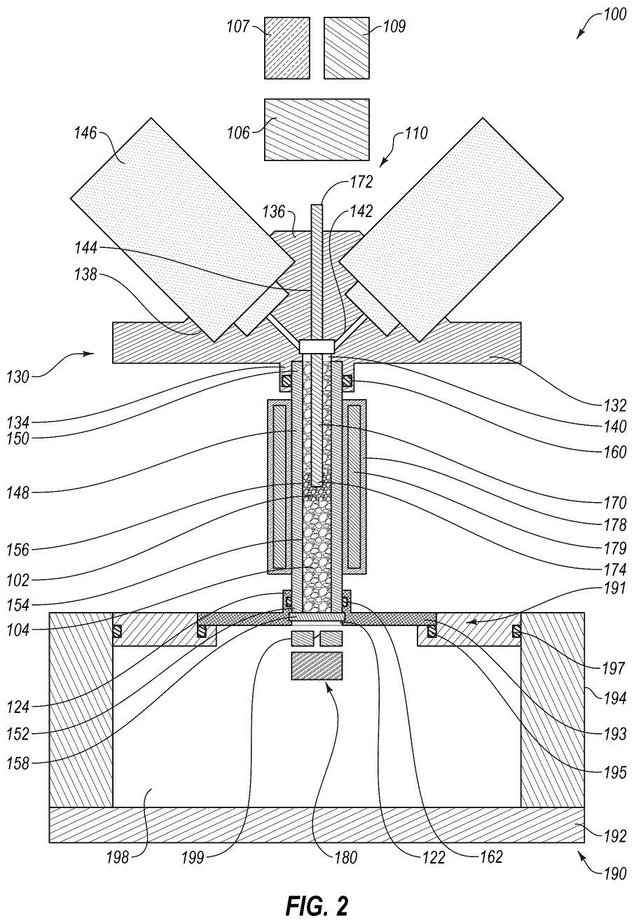

FIG. 2 is a schematic illustration of a reactor system 100 in accordance with embodiments of the disclosure. Referring to FIG. 2, in various embodiments, the manifold 136 connects directly to the reactor tube 148. The manifold 136 includes the upper receiving portion 134 with the blind hole formed therein configured to receive the first end 150 of the reactor tube 148.

In various embodiments, the reactor 110 does not include the housing 112 (refer to FIG. 1) and the reactor 110 is supported at the second end 152 of the reactor tube 148. In various embodiments, the mounting system 190 is configured to support the reactor 110 at the second end 152 of the reactor tube 148 and define the vacuum chamber 198 with the gas measurement device 180 positioned within the vacuum chamber 198. In various embodiments, the mounting system 190 includes a reactor coupling flange 191 and a reactor mount 193. The reactor mount 193 is configured to couple to the second end 152 of the reactor tube 148. The reactor mount 193 may include the lower receiving portion 124 and may be configured to receive a lower seal 162 for forming a seal between the reactor mount 193 and the reactor tube 148 to ensure that the vacuum is maintained within the vacuum chamber 198. The reactor coupling flange 191 is configured to couple the reactor mount 193 to the mount walls 194. The reactor coupling flange 191 is configured to accommodate a flange seal 195 configured to form a seal between the reactor coupling flange 191 and the reactor mount 193. The reactor coupling flange 191 is also configured to accommodate a wall seal 197 configured to form a seal between the reactor coupling flange 191 and the mount walls 194.

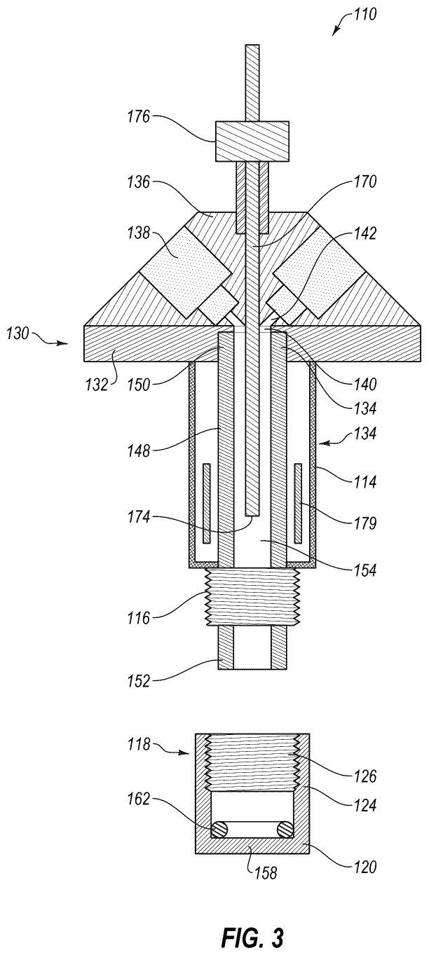

FIG. 3 is a cross-sectional view of a reactor 110 of a reactor system 100 in accordance with embodiments of the disclosure. Various components of the one or more embodiments of the reactor 110 of FIG. 2 may be combined with or included in one or more embodiments of the reactor 110 of FIG. 1 or one or more embodiments of the reactor 110 of FIG. 2. Referring to FIG. 3, in various embodiments, the housing wall 114 is unitarily formed with the cap body 132, permanently joined to the cap body 132, or joined to the cap body 132 in a sealed manner, while the housing base 118 is configured to removably attach to the housing wall 114 to define the housing chamber 128 with the housing wall 114 and the cap 130. In various embodiments, the housing base 118 is configured to engage the housing wall 114 (e.g., via threads or an interference fit, without limitation) for removable attachment. The housing base 118 may include threading 126 (e.g., internal or external threading) formed therein, and the housing wall 114 may include threading 116 (e.g., external or internal threading) formed therein configured to mate with threading 126 to join the housing base 118 to the housing wall 114.

In various embodiments, the housing wall 114 includes the heating element 179 integrated therein (e.g., the housing wall 114 including a low emissivity ceramic with the heating element 179 cast therein, without limitation). The housing wall 114 may be sized to receive the reactor tube 148 with a slip fit or minimal clearance to optimize heat transfer from the heating element 179 to the reaction chamber 154.

In various embodiments, the upper receiving portion 134 includes a blind hole formed in the cap body 132 configured to receive the first end 150 of the reactor tube 148 therein. The blind hole is in fluid communication with the manifold outlet 140 and may be formed in the cap body 132 opposite the gas manifold 136.

In various embodiments, the reactor 110 includes a waveguide seal 176 configured to prevent leakage between the waveguide 170 and the gas manifold 136 and/or the cap 130. The waveguide seal 176 may be configured to accommodate the reactor pressures (e.g., pressures ranging from sub-ambient to about 35 psig or pressures of about 10⁻⁸ to about 10³ torr, without limitation).

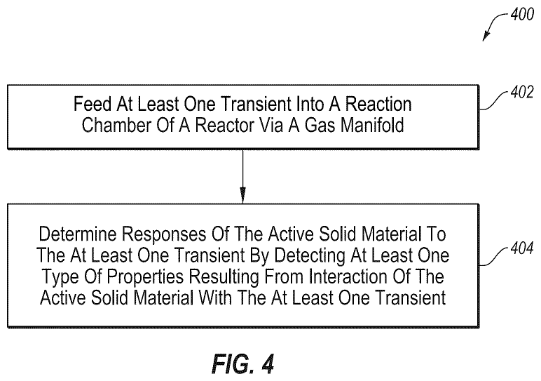

FIG. 4 is a flowchart of a method 400 for analyzing an active solid material, such as for the study of the active solid material to understand the kinetic response of photonic stimulation and/or gas transient stimulation. The method 400 includes feeding at least one transient chosen from among a transient gas and a light transient into a reaction chamber of a reactor via a gas manifold at act 402. The active solid material, such as a catalyst, may be contained in the reaction zone of the reaction chamber. The reactor may be any of the embodiments of the reactor 110 disclosed herein. Act 402 may include using a pulse response methodology to slowly titrate the active solid material with a gas reactant. Act 402 may include flowing gas and a fast gas transient (e.g., switch or pulse, without limitation). In various embodiments, the active solid material may be pretreated in an ambient pressure flow, oxidized, reduced, or reaction equilibrated, without limitation, prior to act 402.

The method includes determining responses of the active solid material to the at least one transient by detecting at least one type of properties, chosen from among properties of light and properties of gas, resulting from interaction of the active solid material with the at least one transient at act 404. Act 404 may generally include one or more of: characterization of solid materials in a gas environment, such as spectroscopic (e.g., scattering, emission, absorption, etc.) characterization of the active solid material in a gas environment, including flow of the gas at elevated temperatures (e.g., a thermal catalytic material under working conditions, without limitation); flow the gas and a fast gas transient (e.g., switch or pulse, without limitation) and detect fast gas transients; study of photocatalytic processes; observation of the effects of optical stimulation (e.g., with varying frequency, intensity, exposure, etc.) on structural and kinetic properties of the active material; transient and transient kinetic studies (e.g., pulse response, switching, frequency modulation, ramping, without limitation) of gas concentration, pressure, and temperature. The design of the device enables; the characterization of the resulting change in structural and kinetic features from incremental titration and manipulation of solid material composition (e.g., concentration of oxygen, nitrogen, carbon, without limitation); fast time response (e.g., millisecond time resolution) detection of changes in both the gas phase and surface spectroscopic features; isothermal kinetic studies and facile separation of gas transport; kinetic effects in transient experiments; and studies of the interaction of light with a reaction mechanism (e.g., changes in kinetics, reaction mechanism). For example, acts 402 and 404 may include one of: i) feed a gas transient and monitor the spectral response of the catalyst and the gas response at the reactor exit; ii) implement as light stimulation together with a gas transient and monitor the gas transient at the reactor exit (spectral response of the catalyst can be included but is optional); and iii) implement light stimulation without a gas transient and monitor the gas response at the reactor exit (desorbed species) (the spectral response of the catalyst can be included but is optional).

In various embodiments, act 404 includes detecting a change in a spectroscopic feature of the active solid material in response to a gas phase transient of the gas. For example, a small (e.g., nanomolar) amount of gas may be injected into the evacuated reactor tube 148 via the one or more valves 146 (e.g., a pulse valve). Changes in the gas response via interaction with the active solid material 102 are measured with the gas measurement device 180 while light is coupled into the waveguide 170 via optics 106 which also collect light that has interacted with the material surface to be interpreted by the light detection system 109. Act 404 may include the use of two or more spectrometers (e.g., a mass spectrometer, a Raman spectrometer, an IR spectrometer, or a UV-VIS spectrometer, without limitation).

In various embodiments, the method includes incrementally changing a kinetic state of the active solid material and act 404 includes observing gas phase kinetics (i.e., reaction rates and mechanisms for chemical processes occurring on the surface of the active solid material) and one or more spectroscopic structural features. Light is coupled into the waveguide 170 via the optics 106 to the active solid material 102. Light that has interacted with the solid, in the presence of gas injected by the pulse valve, is scattered and/or emitted back into the waveguide 170 towards optics 106 which directs the light to the light detection system 109.

In various embodiments, act 404 includes photonically stimulating the active solid material and detecting a kinetic response of photonic stimulation of the active solid material. In various embodiments, photonically stimulating the active solid material and detecting a kinetic response of photonic stimulation of the active solid material includes photonically stimulating the active solid material in tandem with one or more pulses of the gas, which may capture both the fast and slow change of the kinetic state of the active solid material (e.g., from an oxidized to a reduced state, without limitation). In a further embodiment, the gas pulse is not required with the photonic stimulation and the reaction or desorption of chemical species from the active solid material can be recorded using the gas phase detector at the reactor exit. The incremental change may be that from one pulse measurement to the next if there is no detectable change in the kinetic state within the two measurements. The change in the solid active material can also be spectroscopically detected on the same time-scale (milliseconds) as the gas detection. Act 404 may include detecting, enabling, and/or measuring a change less than about 0.01% of the total change.

The method 300 may include using UV-VIS diffuse reflectance spectroscopy, that may be performed outside of the Knudsen diffusion regime (>10 nmol/pulse) with typical pressures inside the reactor 10⁻⁷-10⁻⁶ torr.

In various embodiments, the method 400 includes maintaining a steady state temperature of the active solid material in the reaction chamber by applying heat via a heating element surrounding a reaction zone of the reaction chamber (e.g., encompassing an entirety of the radial aspect of the reaction zone, without limitation). In various embodiments, the reactor (e.g., the reaction zone and/or the reaction chamber, without limitation), is heated from about 25° C. to about 1200° C., from about 25° C. to about 850° C., or up to a temperature less than about 650° C.

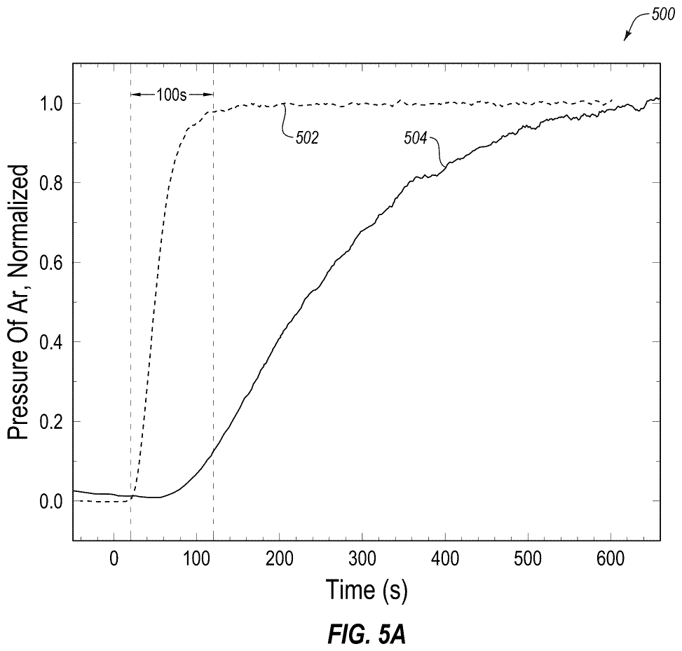

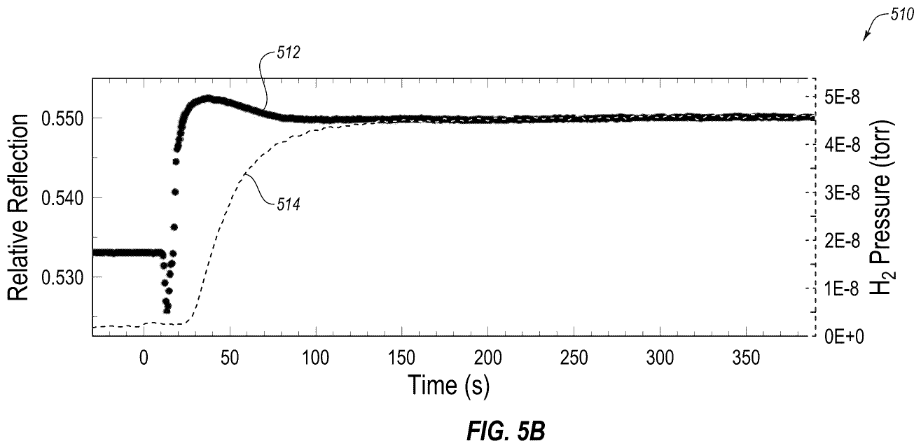

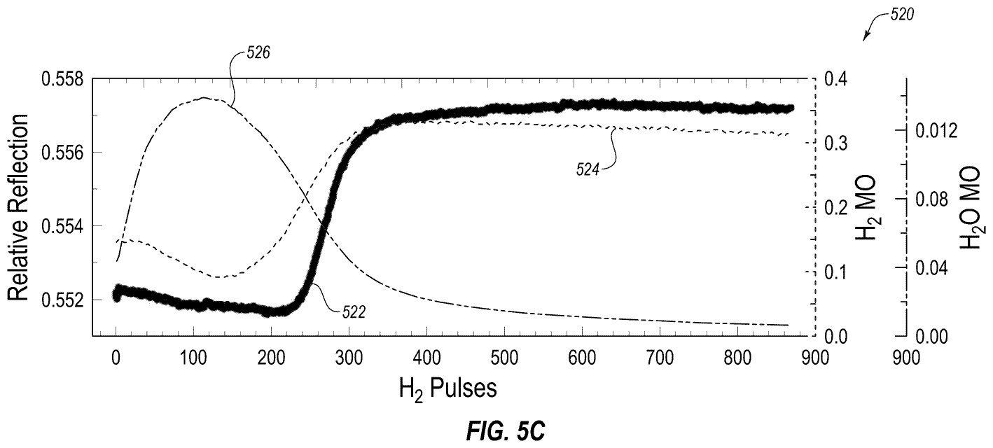

In various embodiments, the reactor is held under vacuum during the method 300. FIG. 5A is a graph 500 illustrating a comparison of test results obtained between using an embodiment of the reactor of the disclosure and a commercial reactor, representing a switch in the gas feed concentration detected from a commercial device and an embodiment of the reactor 110. In particular, FIG. 5A illustrates a comparison of gas transport data 402 obtained using an embodiment of the reactor 110 and gas transport data 504 obtained using a commercial Harrick High Temperature Reaction Chamber operated (each packed with quartz) at 550° C. with a flow of 2 standard cubic centimeters per minute (sccm) of argon (Ar) added to a 10 sccm flow of dinitrogen (N₂) at zero seconds. FIGS. 5B and 5C are graphs 510, 520 illustrating test results using an embodiment of the reactor 110. In particular, FIGS. 5B and 5C are UV-VIS spectroscopy (average reflection between 820-920 nm) and mass spectrometry data collected during hydrogen (H₂) reduction of an oxidized chromia catalyst at 550° C. inside an embodiment of the reactor 110. The reduction was conducted in flow (0.6 sccm H₂+11.4 sccm Ar, (FIG. 5B)) or by pulse titration in vacuum (30 nmol H₂+30 nmol Ar (FIG. 5C)). The gas response in the pulse titration data is the zeroth moment of the flux response and represents the amount of gas at the detector.

Referring to FIG. 5A, with embodiments of the reactor 110, Ar arrives at the mass spectrometer (MS) within 20 seconds and maintains a steady concentration after another 100 seconds, in contrast to the commercial Harrick Cell where it takes four times longer for Ar to initially arrive at the MS and over 660 seconds to reach a steady concentration.

While the reactor 110 may improve transport during flow experiments compared to commercially available apparatus, the reactor 110 may also operate using a pulse response methodology to slowly titrate a catalyst with reactant or other probe molecule.

Separate hydrogen reductions of 20 mg chromia catalyst (CrOₓ/Al₂O₃) were performed in an embodiment of the reactor 110 heated to 550° C., one with flow (FIG. 5B) and one with pulsed titration (FIG. 5C). Before each experiment, 10 sccm of a 20:80 oxygen (O₂):Ar mixture was passed for 20 minutes to ensure the catalyst was completely oxidized. In the first experiment (FIG. 5B), the catalyst was reduced with 10 sccm of a 6:94 H₂:Ar mixture at 1 atm while changes in the diffuse reflectance (relative reflection data 512) were monitored. Even at the very slow H₂ flow (at pressure illustrated by data 414), the Cr⁶⁺ ions are rapidly and fully reduced to Cr³⁺ before H₂ arrives at the MS; reduction of the catalyst surface measured spectroscopically cannot be separated from gas transport. Furthermore, thermal effects such as the temperature of the reactor 110 equilibrates after the initial flow cannot be ruled out as contributing to the initial dip in reflectivity. In the second case, the experiment was performed under typical TAP conditions, i.e., pulsing a 50:50 H₂:Ar mixture into an embodiment of the reactor 110 held under vacuum every 5.6 s, (FIG. 5C). Here, the reaction proceeds slowly with the reflection (relative reflection data 522) synchronized to the gas response, resolving water formation (water formation data 426 relative to H₂ data 524) proceeding Cr⁶⁺ reduction. The fully oxidized catalyst stores oxygen not associated with the chromium centers, and this oxygen needs to be removed before reduction can proceed. FIG. 5B and FIG. 5C illustrate the capability of embodiments of the reactor 110 to resolve transient phenomena via pulsed titration that are unresolvable with commercial flow instruments. Indeed, the transient in the water detected using an embodiment of the reactor 110 (refer to 526 of FIG. 5C), was not detectable by the commercial flow instruments (refer to FIG. 5B).

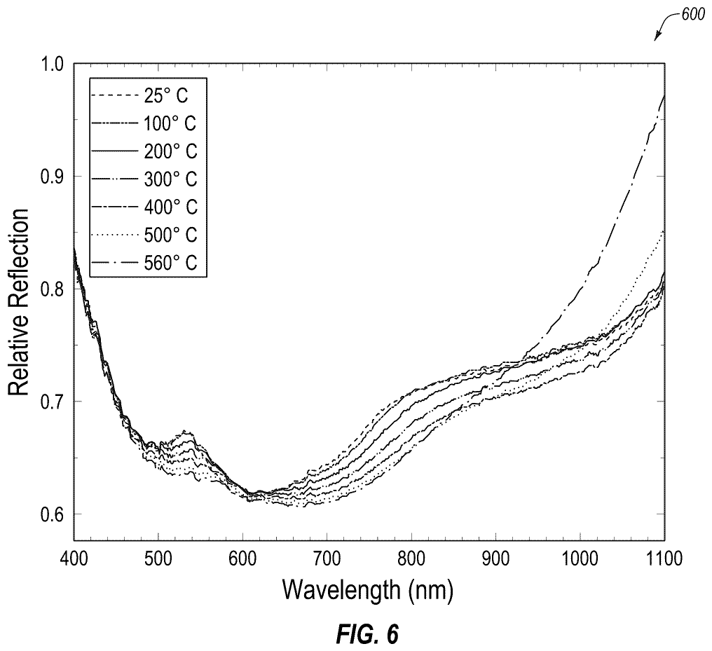

FIG. 6 is a graph 600 illustrating UV-VIS diffuse reflectance spectra of a chromia catalyst heated in air taken at different temperatures. Referring to FIG. 6, along with an ability to titrate a catalyst while conducting operando experiments performed in TAP, the reactor 110 may be configured to perform these experiments under isothermal conditions (e.g., utilizing the heater 178/heating element 179). As illustrated in FIG. 6, the reflection of metal oxide catalysts is highly dependent on the temperature of the system. Upon heating the oxidized chromia catalyst, the Cr³⁺ the relative reflections shift, broaden, and decrease in amplitude (FIG. 6). By 500° C., the spectrum is further complicated by the contribution of blackbody radiation to the signal in the near infrared (NIR), which is also the most sensitive region of the spectrum to the chromium oxidation state. Operando spectroscopy of highly endo-or exo-thermic reaction systems (such as propane dehydrogenation, dH=124 kJ/mol) will be complicated by these thermal effects, which illustrates the importance of operando spectroscopy being performed under isothermal conditions such as the TAP pulse response methodology.

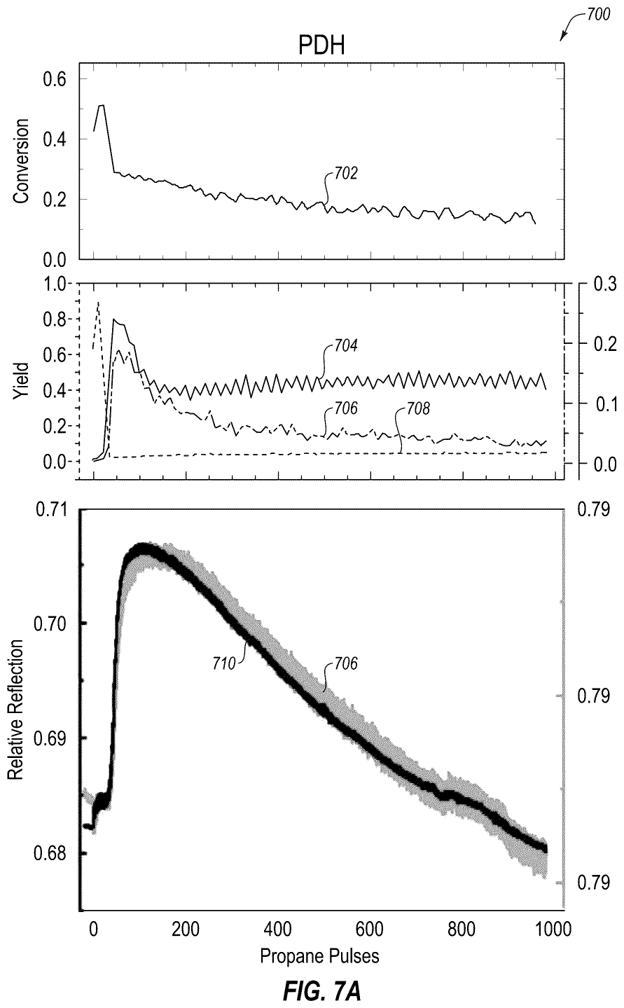

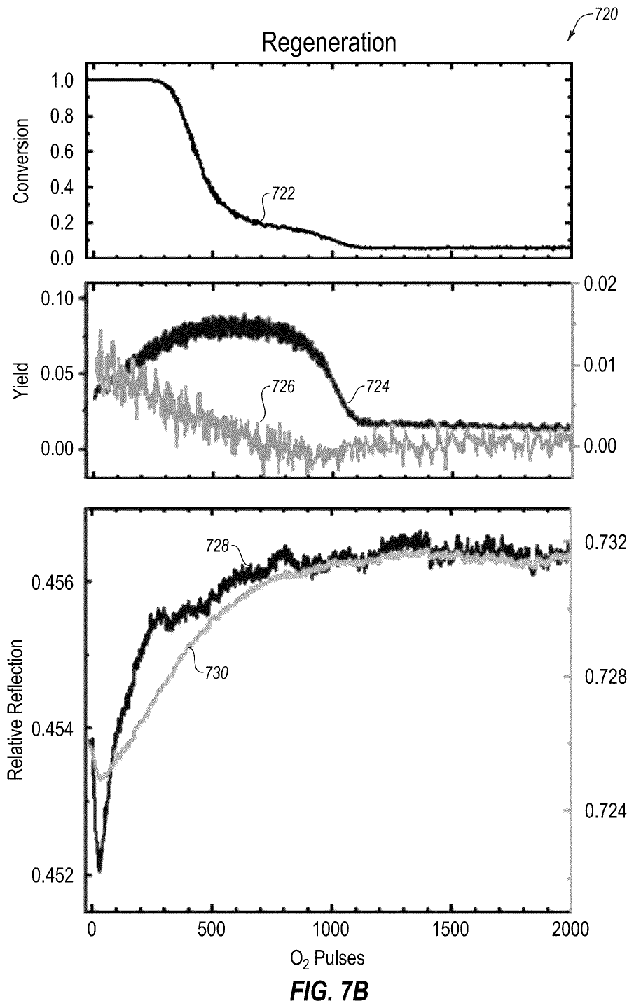

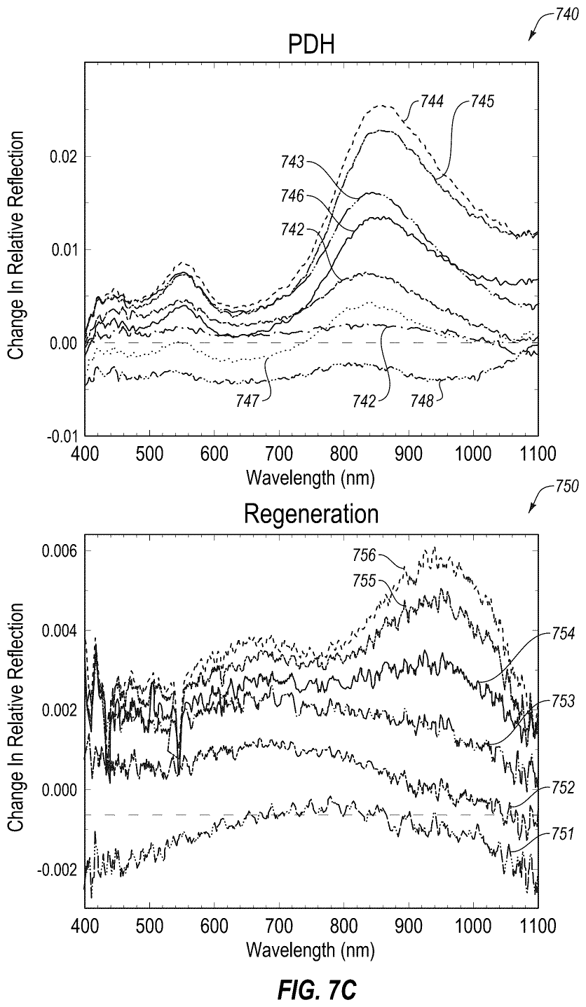

FIGS. 7A-7C are graphs illustrating test results of embodiments of the reactor, reactor system, and methods of the disclosure. In particular, FIGS. 7A-7C illustrate data collected from experiments on a chromia catalyst at 550° C. FIG. 7A includes graphs 700 illustrating results from propane dehydrogenation (PDH) on an oxidized chromia catalyst including (top) propane conversion (propane conversion data 702), (middle) major product yields (C₃H₆ data 704, H₂ data 706, and CO₂ data 708) as a function of propane pulses (30 nmol propane+30 nmol He), (bottom) UV-VIS diffuse reflectance transients taken as the average signal in the range 820-920 nm (data 610) and 1000-1100 nm as a function of propane pulses (data 612). FIG. 7B includes graphs 720 illustrating results from a subsequent oxidation regeneration of coked catalyst including (top) oxygen conversion (oxygen conversion data 722), (middle) major product yields (CO₂ data 724 and CO data 726) as a function of O₂ pulses (30 nmol O₂+30 nmol Ar), and (bottom) UV-VIS diffuse reflectance transients taken as the average signal in the range 480-520 nm (data 728) and 900-1000 nm as a function of O₂ pulses (data 730). FIG. 7C includes graph 740, 750 results from a UV-VIS diffuse reflectance spectra, plotted as the difference in reflection at pulse N minus the reflection before pulsing during PDH (graph 740) and O₂ regeneration (graph 750). Each data set represents the pulse number the measurement was taken at (top: data 741 represents pulse number 14; data 742 represents pulse number 42; data 743 represents pulse number 50; data 744 represents pulse number 113; data 745 represents pulse number 205; data 746 represents pulse number 428; data 747 represents pulse number 726; and data 748 represents pulse number 1000; and bottom: data 751 represents pulse number 32; data 752 represents pulse number 138; data 753 represents pulse number 245; data 754 represents pulse number 362; data 755 represents pulse number 726; and data 756 represents pulse number 1000).

Referring to FIGS. 7A-7C, an embodiment of the reactor 110 was used to monitor the PDH dynamics of 25 mg oxidized chromia catalyst at 550° C. (FIG. 7A). The first 40 propane pulses combust on the catalyst to form CO₂. Changes in the reflectance are negligible and the full spectrum, plotted as the difference of the pulse N reflection minus the reflection before pulsing, does not take on the spectrum of Cr³⁺ (FIG. 7C). The initial propane pulses do not reduce Cr⁶⁺ to Cr³⁺ but react with the stored oxygen not bound to the chromium centers. After the initial combustion period, the next 30 pulses show a rise in H₂ and propylene yield. Simultaneously, the reflection increases and takes on the shape of the Cr³⁺ spectrum, indicative of catalyst reduction. Other reports suggest Cr³⁺ centers are the active site for dehydrogenation reactions, and the correlation here between product yield and reduction indicate the redox active Cr³⁺ centers are the PDH active site. Continued pulsing leads to a drop in propane conversion and propylene yield. A steady decrease in reflection is the result of coke formation on the catalyst surface and results in blocking of the active sites and loss of catalyst activity. The three separate kinetic responses (combustion, reduction, and PDH) are uniquely resolvable using embodiments of the reactor 110.

The coked chromia catalyst was subsequently regenerated with O₂:Ar (50:50) pulsing at 550° C. (FIG. 7B). Initially, O₂ is fully consumed concomitant with CO and CO₂ release (coke combustion). The UV-VIS data decreases at these early pulse numbers which is unexpected given that coke on the catalyst surface is dark and matte. Instead, the decrease in reflection from oxidation of Cr³⁺ to Cr⁶⁺ in the first 50 pulses contributes more to the UV-VIS signal than brightening from carbon removal. The CO response (CO data 626) drops with continued pulsing while CO₂ (CO₂ data 724) increases and reaches a maximum of 500 pulses. There are two types of carbon on the catalyst surface and/or mechanisms for coke combustion: one where carbon is oxidized as CO preferentially coming off the catalyst early in the oxidation and another as CO₂ coming off the catalyst later in the oxidation. After the first 50 pulses, the reflection begins to increase as coke is removed and a stable maximum around the same point the CO and CO₂ yields return to zero. An advantage of embodiments of the reactor 110 includes an ability to resolve the kinetic processes, the oxidation of the material and the oxidation of carbon, which are not resolvable using conventional systems.

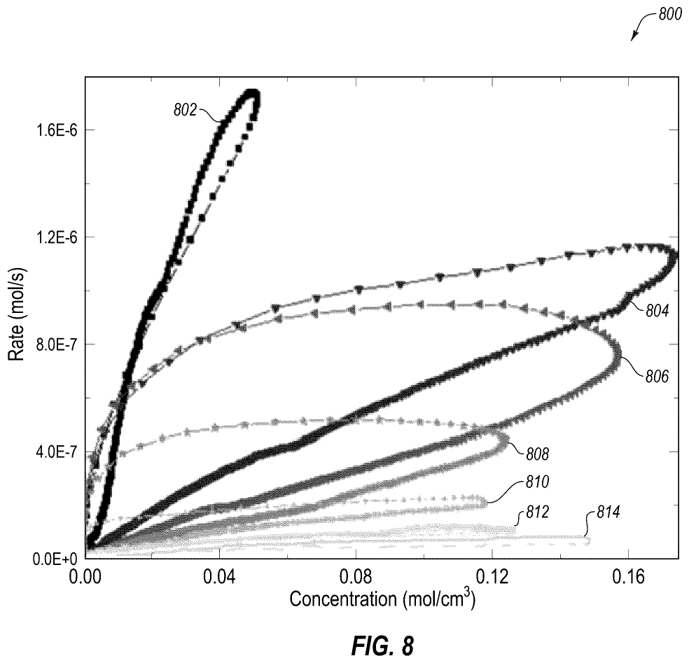

FIG. 8 is a graph 800 illustrating test results of embodiments of the reactor 110 of the disclosure. Graph 800 illustrates the ability of the reactor 110 to resolve time-dependent rate and concentration data during each pulse response using a TAP methodology and advanced mathematical procedures according to TAP pulse response data. In graph 800 the pulse-to-pulse propane conversion is calculated from the integral of the flux response, but detailed time-dependent reaction rate and concentration are also determined as demonstrated in graph 800 (data 802 represents 1.8 μmol, data 804 represents 5.7 μmol, data 806 represents 7.5 μmol, data 808 represents 13 μmol, data 810 represents 26 μmol, data 812 represents 55 μmol, and data 814 represents 93 μmol. Such features may be determined using the TAP pulse response methodology utilizing embodiments of the reactor 110.

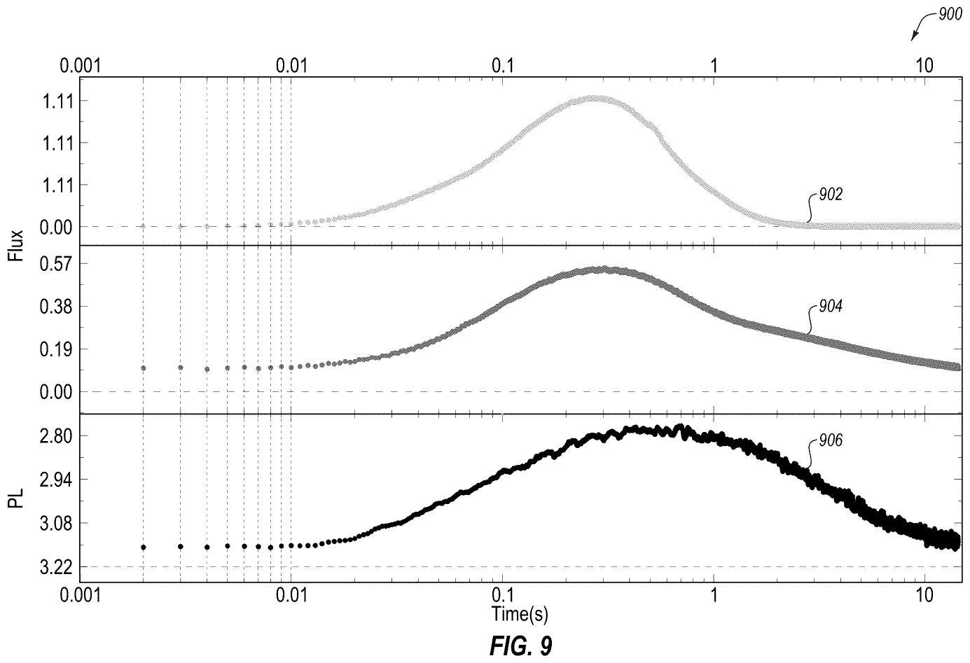

FIG. 9 is a graph 900 illustrating test results of embodiments of the reactor 110 of the disclosure. Referring to FIG. 9, an embodiment of the reactor 110 was used to monitor the propane dehydrogenation dynamics of a reduced chromia catalyst at 550° C. This includes the gas response of 100 nmol injected propane interacting with the catalyst determined by mass spectrometry (the flux response of reactant propane and product H₂) and the catalyst response to the injected propane determined by photoluminescence (PL). The PL experiment was conducted by focusing a 532 nm laser into the waveguide with the optics and collecting photons emitted from the catalyst using the same waveguide, which then transmitted the light back to the optics. The optics direct emitted photons to the light detection device, a monochromator and photomultiplier tube, for analysis of the chromia photoluminescence at a wavelength of 750 nm. Notably, the light detection system and gas detection system are synchronized, allowing for precise quantification of gas and surface processes/kinetics with 1 ms time resolution. This gas-light synchronization with 1 ms time resolution is unavailable with commercial operando reaction systems.

In FIG. 9, the propane flux 902 reports the kinetics of propane consumption from propane dehydrogenation and coking. The H₂ flux 904 is formed from the same propane dehydrogenation and coking reactions, however its response is longer lived than that of propane consumption (i.e., reactant consumption and product formation have different kinetics). This is attributed to a restructuring of saturated carbon on the catalyst surface to form unsaturated carbon and H2 (e.g., the dehydrogenation catalyst is dehydrogenating coke). At the same time, the PL signal 906 is shown to have a peak intensity that lagged behind the propane flux 902 and H₂ flux 904 with a relaxation time that was also longer than that of the propane flux 902 or H₂ flux 904. This arises from a structural change in the catalyst that is not immediately invoked by gas adsorption but may be formed upon the dehydrogenation and/or coking reactions. The PL signal 906 (the catalyst structure) continued to evolve after all gases have evacuated the reaction chamber, indicating that this structural rearrangement of the chromia is stable (i.e., an energy barrier is overcome for the chromia catalyst to relax back to a starting state after exposure to propane). These observations were enabled by the synchronization of the gas response to the light spectral response with millisecond time resolution provided by embodiments of the reactor system of the disclosure.

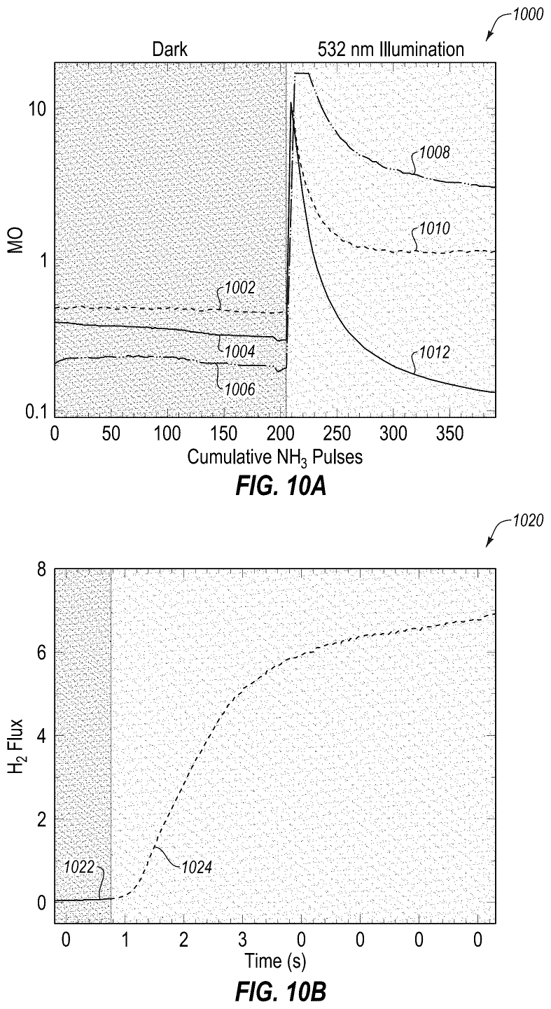

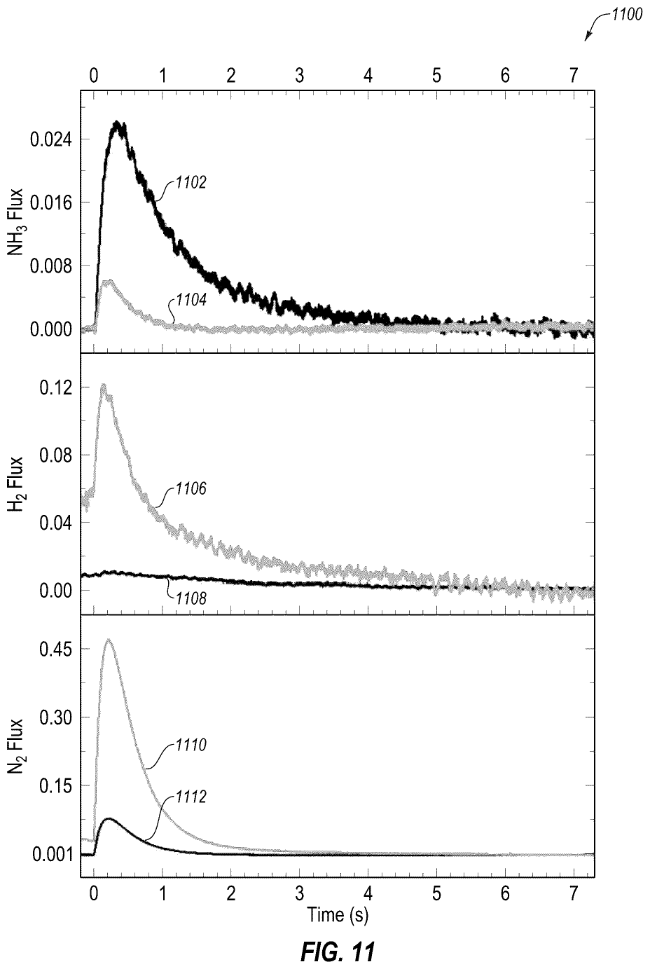

FIGS. 10A and 10B are graphs 1000 and 1020 illustrating test results of embodiments of the reactor 110 of the disclosure. In particular, graph 1000 illustrates an amount of molecules at the mass spectrometer obtained from the integral of the flux response from a dark condition to an illuminated condition (NH₃ data 1004 H₂ data 1006 and N₂ data 1002), and graph 1020 illustrates flux response of H₂ during the pulse from a dark condition (dark data 1008) to when the illumination was turned on at 0.8 s (light data 1010). FIG. 11 is a graph 1100 illustrating test results of embodiments of the reactor 110 of the disclosure. In particular, graph 1100 illustrates a flux response of NH₃ (dark data 1102, light data 1104) H₂ (dark data 1108, light data 1106), and N₂ (dark data 1112, light data 1110) during the first pulse cycle in the dark and last pulse cycle under illumination.

Referring to FIGS. 10A-11, an embodiment of the reactor 110 was used to study the decomposition of NH₃ to H₂ and N₂ over a copper-ruthenium (Cu—Ru) photocatalyst at 300° C. (FIGS. 10A-11). The first half of the experiment was conducted in the dark and the second half was conducted under 532 nm illumination waveguided through the sapphire rod to optically excite the plasmon resonance of Cu nanoparticles. In the dark (FIG. 10A, 0-200 cumulative NH₃ pulses) some NH₃ decomposition was observed with a minor N₂ yield, illustrated as the relative number of molecules at the detector, M0. The H₂ yield of the thermal decomposition is negligible, indicating H₂ is irreversibly binding to the catalyst surface.

At 200 cumulative NH₃ pulses (FIG. 10A), the illumination was turned on and a large, immediate spike in the number of NH₃, N₂, and H₂ molecules at the detector was observed. The excitation of the Cu plasmon resonance with 532 nm irradiation significantly increased the rate of gas desorption, releasing surface bound species that were accumulated on the catalyst during dark pulsing. This effect can further be observed during the H₂ pulse where the illumination was turned on at 0.8 s (FIG. 10B), manifested as a rapid increase in the H₂ signal over the course of 7 seconds. The timescale achieved is fast compared to conventional momentum driven flow photoreactors, which would miss the kinetics, indicating gas desorption is facilitated by the application of light.

FIG. 11 shows the NH₃, H₂, and N₂ flux responses obtained in the embodiment of the reactor 110 for the first dark pulse cycle and last illuminated pulse cycle. A decrease in the NH₃ flux response in the presence of light indicates excitation of the Cu plasmon resonance leads to higher NH₃ conversion than purely thermal activation. Increased yields were also observed in the product (H₂, N₂) fluxes which are larger under irradiation. These flux curves in FIG. 11 provide the basis for extracting detailed kinetic information of the Cu—Ru catalyst to understand how light interacts with individual reaction steps.

The reactor of the disclosure is configured to improve upon limitations in existing devices used for kinetic analysis; specifically, in certain embodiments, deviations from ideal plug flow or continuous stirred tank behavior. The reactor disclosed herein may provide an ability to carry out steady-state kinetic studies, may accommodate transient experiments, may improve the gas response time of gas transient detection with an ability to capture the spectral response on the time scale of typical reaction kinetics (i.e., milliseconds), may operate under an isothermal condition by preventing temperature gradients from forming within the active sold material, may detect the temporal change of a singular spectral feature of interest, may capture the kinetic rate constants that are typical to the reaction network for the adsorption and catalytic reactions in the temperature range of their normal operational use, may enable detailed time-dependent kinetic analysis as the gas pulse changes surface concentration, and may enable characterization of the kinetic response of chemically active solid material to both photonic and gas phase transients.

The reactor system may help identify which surface structural components of a heterogeneous catalyst are responsible for accelerating/suppressing desired and undesired reaction steps, which may guide the development of more active, selective, cost effective and environmentally benign catalyst materials. The reactor system may also guide development of photoactive, photochemical and/or photocatalytic materials. The reactor system may also enable direct study of the influence of photonic stimulation on detailed kinetic and mechanistic phenomena (e.g., time-dependent rates and concentrations, rate constants of adsorption/reaction/desorption and surface reaction acts).

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternate useful combinations of the elements described, will become apparent to those skilled in the art from the description. Such modifications and embodiments also fall within the scope of the appended claims and equivalents.

What is claimed is:

1. A reactor comprising:
a reactor tube defining a reaction chamber for receiving an active solid material and an inert solid material, the reactor tube including a first end and a second end;
a waveguide including a communication end positioned outside of the reaction chamber beyond the first end and a reactor end positioned within the reaction chamber defining a reaction zone within the reaction chamber, the waveguide including an optically transmitting material configured to illuminate or stimulate the active solid material positioned within the reaction zone;
a gas manifold adjoining the first end of the reactor tube, the gas manifold configured to direct gas into the reaction chamber; and
a permeable material restraint positioned at the second end of the reactor tube, the permeable material restraint including a porous solid material configured to hold the inert solid material and the active solid material within the reaction chamber while allowing gas species to pass through for measurements to be performed by a measurement device.

2. The reactor of claim 1, further comprising a heating element positioned radially outward from the reaction chamber and axially overlapping at least the reaction zone.

3. The reactor of claim 1, wherein the porous solid material is chosen from among a perforated screen, and frit.

4. The reactor of claim 1, wherein the gas manifold is configured to feed a transient gas into the reaction chamber.

5. The reactor of claim 1, further comprising a housing configured to receive the reactor tube, the housing comprising:
a base; and
an opening in the base, the base opening substantially aligned with the reactor tube, the base opening configured to receive the material restraint therein.

6. A reactor system comprising:
optics;
a light measurement device configured to receive light from the optics;
a gas measurement device; and
a reactor positioned between the optics and the gas measurement device, the reactor comprising:
a reactor tube defining a reaction chamber for receiving an active solid material and an inert solid material;
a waveguide including:
a communication end positioned outside of the reaction chamber beyond a top of the reactor tube and positioned to send or receive light from the optics; and
a reactor end positioned within the reaction chamber, the waveguide including an optically transmitting material configured to disperse the light received or collected from the optics that allows detection of at least one type of properties from interaction of an active solid material with at least one stimuli chosen from among gas and light;
a gas manifold adjoining top of the reactor tube, the gas manifold configured to accommodate the waveguide and feed the gas into the reaction chamber; and
a permeable material restraint positioned at a bottom of the reactor tube adjacent to the gas measurement device, the permeable material restraint configured to hold the inert solid material and the active solid material within the reaction chamber while allowing gas to pass through for the gas measurement device to detect the at least one type of gas properties.

7. The reactor system of claim 6, wherein the reactor further comprises a heating element positioned radially outward from the reaction chamber and axially overlapping the reactor end of the waveguide.

8. The reactor system of claim 6, wherein the permeable material restraint is a porous solid material chosen from among a perforated screen and, a frit.

9. The reactor system of claim 6, wherein the gas measurement device comprises one or more gas phase detectors configured to detect properties of the gas and the light measurement device comprises one or more spectroscopic detectors configured to detect properties of the light.

10. The reactor system of claim 9, wherein the one or more gas phase detectors and the one or more spectroscopic detectors are configured to detect on a same time scale.

11. The reactor system of claim 6, wherein the reactor further comprises a housing configured to receive the reactor tube therein, the housing comprising:
a base including a base opening formed therein, the base opening substantially aligned with the reactor tube and configured to receive the material restraint therein.

12. The reactor system of claim 11, further comprising a mounting system configured to position the reactor over the measurement device with the base opening aligned with a separator of the measurement device.

13. The reactor system of claim 12, wherein the housing includes a cap configured to receive a top of the reactor tube, and the mounting system includes a reactor support configured to receive the cap and define a vacuum chamber with the cap.

14. A method comprising:
feeding at least one transient chosen from among a gas transient and a light transient into a reaction chamber of a reactor via a gas manifold adjoining a first end of a reactor tube of the reactor, the reactor comprising:
the reactor tube defining the reaction chamber with an active solid material and an inert solid material received therein, the reactor tube including a first end and a second end;
a waveguide including a communication end positioned outside of the reaction chamber beyond the first end and a reactor end positioned within the reaction chamber and within the active solid material defining a reaction zone within the reaction chamber, the waveguide including an optically transmitting material configured to illuminate the active solid material positioned within the reaction zone and to transmit light from the active solid material;
a permeable material restraint positioned at the second end of the reactor tube, the permeable material restraint including a porous solid material holding the inert solid material and the active solid material within the reaction chamber while allowing gas to pass through for measurements to be performed by a measurement device; and
the gas manifold adjoining the first end of the reactor tube; and
determining responses of the active solid material to the at least one transient by detecting at least one type of properties, chosen from among properties of light and properties of gas, resulting from interaction of the active solid material with the at least one transient.

15. The method of claim 14, wherein determining responses of the active solid material to the gas includes detecting a change in a spectroscopic feature of the active solid material in response to a gas phase transient of the gas transient.

16. The method of claim 15, wherein detecting a change in a spectroscopic feature includes detecting a transient gas response and detecting a transient in the spectral response of the active solid material.

17. The method of claim 16, wherein detecting the transient gas response and detecting the transient in the spectral response of the active solid material are performed on a same time scale.

18. The method of claim 14, wherein determining responses of the active solid material to the gas includes incrementally changing a kinetic state of the active solid material and observing a gas phase kinetic and one or more spectroscopic structural features.

19. The method of claim 14, wherein determining responses of the active solid material to the gas includes photonically stimulating the active solid material and detecting a kinetic response of photonic stimulation of the active solid material.

20. The method of claim 19, wherein determining responses of the active solid material to the gas includes measuring a response of the gas transient to photonic stimulation of the active solid material.
